(19) United States
(12) Patent Application Publication
(10) Pub. No.: US 2026/0172089 A1
(43) Pub. Date: Jun. 18, 2026

(54) METHODS, DEVICES AND COMPUTER READABLE MEDIA FOR COMMUNICATION

(71) Applicant: NEC CORPORATION, Tokyo (JP)

(72) Inventors: Gang WANG, Beijing (CN); Yukai GAO, Beijing (CN); Peng GUAN, Beijing (CN)

(73) Assignee: NEC CORPORATION, Tokyo (JP)

(21) Appl. No.: 18/845,185

(22) PCT Filed: Mar. 15, 2022
(86) PCT No.: PCT/CN2022/081002

§ 371 Date: Sep. 9, 2024

(51) Int. Cl. H04B 7/06; H04B 7/0408

(52) U.S. Cl. CPC H04B 7/0626; H04B 7/0408; H04B 7/06952

(57) ABSTRACT

Embodiments of the disclosure relate to methods, devices and computer readable media for communication. According to the embodiments, A terminal device generates a plurality of encoded channel state information, CSI, based on CSI and a plurality of encoding models for CSI feedback. The CSI is obtained based on a CSI reference signal, CSI-RS, from a network device. The terminal device obtains a plurality of recovered CSI. The plurality of recovered CSI is generated based on a plurality of decoding models for CSI feedback and the plurality of encoded CSI. The plurality of decoding models correspond to the plurality of encoding models. Then, the terminal device determines difference information of the plurality of encoding models based on the CSI and the plurality of recovered CSI. Further, the terminal device determines a target encoding model. The target encoding model is determined from the plurality of encoding models based on the difference information.

### FIELD

Embodiments of the present disclosure generally relate to the field of communication, and in particular, to methods, devices and computer readable media for communication.

### BACKGROUND

With the development of communication technology, artificial intelligence (AI) or machine learning (ML) technologies have been widely used for communication. In order to achieve some communication function, a plurality of different AI/ML models may be arranged at both network device and terminal device sides. In this case, the network device or the terminal device may need to determine or select an appropriate model to apply the communication function based on such as performance, latency and computational complexity of the AI/ML algorithms and overhead, power consumption, memory storage and hardware requirements associated with enabling respective AI/ML scheme. Therefore, quality information of a plurality of models available to the communication function may need to be obtained by the network device or the terminal device, and then the network device or the terminal device may select one appropriate model to apply to the communication function. However, among others open issues, how to traverse efficiently the plurality of models to select one appropriate model to apply to the communication function is still an open issue to be addressed.

### SUMMARY

In general, example embodiments of the present disclosure relate to methods, devices and computer readable media for communication.

In a first aspect, there is provided a method implemented by a terminal device. In the method, a terminal device generates a plurality of encoded channel state information, CSI, based on CSI and a plurality of encoding models for CSI feedback. The CSI is obtained based on a CSI reference signal, CSI-RS, from a network device. The terminal device obtains a plurality of recovered CSI. The plurality of recovered CSI is generated based on a plurality of decoding models for CSI feedback and the plurality of encoded CSI. The plurality of decoding models correspond to the plurality of encoding models. Then, the terminal device determines difference information of the plurality of encoding models based on the CSI and the plurality of recovered CSI. Further, the terminal device determines a target encoding model. The target encoding model is determined from the plurality of encoding models based on the difference information.

In a second aspect, there is provided a method implemented by a terminal device. In the method, a terminal device generates a plurality of encoded channel state information, CSI, based on CSI and a plurality of encoding models for CSI feedback, the CSI being obtained based on a CSI-RS from a network device. Then, the terminal device transmits, to the network device, the plurality of encoded CSI and the CSI. Further, the terminal device receives, from the network device, an eighth indication for a target encoding model.

In a third aspect, there is provided a method implemented by a terminal device. In the method, a terminal device receives, from a network device, a ninth indication for a channel state information, CSI, report for model selection for beam prediction. The ninth indication comprises information indicating a plurality of beams to be reported. Then, the terminal device transmits to the network device, reference signal received power, RSRP, of the plurality of beams. The terminal device receives, from the network device, a tenth indication for a beam combination to be reported for beam prediction. The beam combination is a subset of the plurality of beams.

In a fourth aspect, there is provided a method implemented by a terminal device. In the method, a terminal device receives, from a network device, a eleventh indication for a channel state information, CSI, report for model selection for beam prediction. The terminal device obtains, for each model of a plurality of models for beam prediction, processed reference signal received power, RSRP, of a plurality of beams based on the model and RSRP of a subset of the plurality of beams associated with the model. A different model corresponding to a different beam combination. The terminal device determines, for each model of the plurality of models, a RSRP difference based on the RSRP of the plurality of beams and the processed RSRP of the plurality of beams associated with the model. Then, the terminal device determines a target model. The target model is determined based on the plurality of RSRP differences from the plurality of models.

In a fifth aspect, there is provided a method implemented by a network device. In the method, a network device receives from a terminal device, a plurality of encoded channel state information, CSI. The plurality of encoded CSI is obtained based on CSI and a plurality of encoding models for CSI feedback. The CSI is obtained based on a CSI reference signal, CSI-RS, from the network device. Then, the network device generates a plurality of recovered CSI based on the plurality of encoded CSI and a plurality of decoding models corresponding to the plurality of encoding models. Further, the network device transmits, to the terminal device, the plurality of recovered CSI. Then, the network device determines a target decoding model. The target decoding model is determined from the plurality of decoding models based on difference information of the plurality of decoding models. The difference information is determined based on the CSI and the plurality of recovered CSI. The target decoding model corresponds to a target encoding model at the terminal device.

In a sixth aspect, there is provided a method implemented by a network device. In the method, the network device receives, from a terminal device, channel state information, CSI, and a plurality of encoded CSI. The CSI is obtained based on a CSI-RS from the network device. The plurality of encoded CSI is generated based on the CSI and a plurality of encoding models for CSI feedback. Then, the network device generates a plurality of recovered CSI based on the plurality of encoded CSI and a plurality of decoding models for CSI feedback. The plurality of decoding models correspond to the plurality of encoding models. The network device determines a target decoding model from the plurality of decoding models based on difference information of the plurality of decoding models. The difference information is determined based on the CSI and the plurality of recovered CSI. The network device transmits, to the terminal device, an eighth indication for a target encoding model, the target encoding model corresponding to the target decoding model.

In a seventh aspect, there is provided a method implemented by a terminal device. In the method, a network device transmits, to a terminal device, a ninth indication for a channel state information, CSI, report for model selection for beam prediction. The ninth indication comprising information indicating a plurality of beams to be reported. The network device obtains, for each model of a plurality of models for beam prediction, processed reference signal received power, RSRP, of a plurality of beams based on the model and RSRP of a subset of the plurality of beams associated with the model. A different model corresponding to a different beam combination. RSRP of the plurality of beams is received from the terminal device. The network device determines, for each model of the plurality of models, a RSRP difference based on the RSRP of the plurality of beams and the processed RSRP of the plurality of beams associated with the model. Then, the network device determines a target model from the plurality of models based on a plurality of RSRP differences associated with the plurality of models. A different model corresponds to a different beam combination. Then, the network device transmits, to the terminal device, a tenth indication for a beam combination to be reported for beam prediction, the beam combination being associated with the target model.

In an eighth aspect, there is provided a method implemented by a terminal device. In the method, a network device transmits, to a terminal device, an eleventh indication for a channel state information, CSI, report for model selection for beam prediction. The network device receives, from the terminal device, a plurality of reference signal received power, RSRP, differences associated with a plurality of models for beam prediction, RSRP difference associated with each model of the plurality of models being determined based on RSRP of a plurality of beams and processed RSRP of the plurality of beams associated with the model, wherein the processed RSRP of the plurality of beams associated with the model are obtained based on the model and RSRP of a subset of the plurality of beams associated with the model, a different model corresponding to a different beam combination. Then, the network device determines a target model from the plurality of models, based on the plurality of RSRP differences associated with the plurality of models. The network device transmits, to the terminal device, a twelfth indication for the target model or a beam combination associated with the target model.

In the ninth aspect, there is provided a terminal device. The terminal device comprises a processor and a memory coupled to the processor and storing instructions thereon, the instructions, when executed by the processor, causing the terminal device to perform the method of any one of the first aspect to the fourth aspect.

In the tenth aspect, there is provided a network device. The network device comprises a processor and a memory coupled to the processor and storing instructions thereon, the instructions, when executed by the processor, causing the network device to perform the method of any one of the fifth aspect to the eighth aspect.

In the eleventh aspect, there is provided a computer readable medium having instructions stored thereon, the instructions, when executed on at least one processor, causing the at least one processor to perform the method of any one of the first aspect to the eighth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which some embodiments of the present disclosure can be implemented;

FIG. 2 illustrates a signaling process for model selection for CSI feedback between the network device and the terminal device according to some embodiments of the present disclosure;

FIG. 3 illustrates a signaling process for model selection for CSI feedback between the network device and the terminal device according to some other embodiments of the present disclosure;

FIG. 4 illustrates a signaling process for model selection for CSI feedback between the network device and the terminal device according to some further embodiments of the present disclosure;

FIG. 5 illustrates a signaling process for model selection for beam prediction between the network device and the terminal device according to some embodiments of the present disclosure;

FIG. 6 illustrates a signaling process for model selection for beam prediction between the network device and the terminal device according to some other embodiments of the present disclosure;

FIG. 7 illustrates a flowchart of an example method of communication implemented at a terminal device in accordance with some embodiments of the present disclosure;

FIG. 8 illustrates a flowchart of an example method of communication implemented at a terminal device in accordance with some embodiments of the present disclosure;

FIG. 9 illustrates a flowchart of an example method of communication implemented at a network device in accordance with some embodiments of the present disclosure;

FIG. 10 illustrates a flowchart of an example method of communication implemented at a network device in accordance with some embodiments of the present disclosure;

FIG. 11 illustrates a flowchart of an example method of communication implemented at a terminal device in accordance with some embodiments of the present disclosure;

FIG. 12 illustrates a flowchart of an example method of communication implemented at a terminal device in accordance with some embodiments of the present disclosure;

FIG. 13 illustrates a flowchart of an example method of communication implemented at a network device in accordance with some embodiments of the present disclosure;

FIG. 14 illustrates a flowchart of an example method of communication implemented at a network device in accordance with some embodiments of the present disclosure;

FIG. 15 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have AI or ML capability. It generally includes one or more models which have been trained from numerous collected data for a specific function, and can be used to predict some information.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR 1 (410 MHz-7125 MHz), FR 2 (24.25 GHz to 71 GHz), 71 GHz to 114 GHz, and frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, with the development of communication technology, AI or ML technologies have been widely used for communication. In the third generation partnership project (3GPP) Release 18 (Rel-18), there are some discussions about AI/ML for air interfaces, especially for some communication functions such as CSI feedback enhancements and beam management. Thus, to achieve the above communication functions, a plurality of different AI/ML models are arranged at both network device and terminal device sides. Then, the network device or the terminal device may determine an appropriate model to apply the communication function based on such as performance, latency and computational complexity of the AI/ML algorithms and overhead, power consumption, memory storage and hardware requirements associated with enabling respective AI/ML scheme. For example, the model may be determined according to some rules, for example, the highest accuracy, the lowest overhead, or a trade-off between the accuracy and the overhead. Therefore, quality information of a plurality of models available to the communication function may need to be obtained by the network device or the terminal device, and then the network device or the terminal device may select one appropriate model to apply to the communication function.

Thus, there is a need to select one appropriate model from the plurality of models to apply to the communication function. Besides, by now, there is no effective way to determine the appropriate model to further improve communication efficiency.

In an aspect, some embodiments of the present disclosure provide a scheme of model determination for CSI feedback. With the scheme, a terminal device generates a plurality of encoded CSI based on CSI and a plurality of encoding models for CSI feedback. The CSI is obtained based on CSI-RS from a network device. The terminal device obtains a plurality of recovered CSI. The plurality of recovered CSI is generated based on a plurality of decoding models for CSI feedback and the plurality of encoded CSI. The plurality of decoding models correspond to the plurality of encoding models. Then, the terminal device determines difference information of the plurality of encoding models based on the CSI and the plurality of recovered CSI. Further, the terminal device determines a target encoding model. The target encoding model is determined from the plurality of encoding models based on the difference information.

In another aspect, some other embodiments of the present disclosure provide a further scheme of model determination for CSI feedback. With the scheme, a terminal device generates a plurality of encoded CSI based on CSI and a plurality of encoding models for CSI feedback. Then, the terminal device transmits, to the network device, the plurality of encoded CSI and the CSI. Further, the terminal device receives, from the network device, an eighth indication for a target encoding model.

In a further aspect, some embodiments of the present disclosure provide a scheme of model determination for beam prediction. With the scheme, a terminal device receives, from a network device, an indication for a CSI report for model selection for beam prediction. The indication comprises information indicating a plurality of beams to be reported. Then, the terminal device transmits to the network device RSRP of the plurality of beams. The network device obtains, for each model of a plurality of models for beam prediction, processed RSRP of the plurality of beams based on the model and RSRP of a subset of the plurality of beams associated with the model. The network device determines, for each model of the plurality of models, a RSRP difference based on the RSRP of the plurality of beams and the processed RSRP of the plurality of beams associated with the model. Then, the network device determines a target model from the plurality of models based on a plurality of RSRP differences associated with the plurality of models. Then, the network device transmits, to the terminal device, an indication for a beam combination associated with the target model to be reported for beam prediction.

In yet a further aspect, some other embodiments of the present disclosure provide a further scheme of model determination for beam prediction. With the scheme, a terminal device receives, from a network device, an indication for a CSI report for model selection for beam prediction. The terminal device obtains, for each model of a plurality of models for beam prediction, processed RSRP of a plurality of beams based on the model and RSRP of a subset of the plurality of beams associated with the model. The terminal device determines, for each model of the plurality of models, a RSRP difference based on the RSRP of the plurality of beams and the processed RSRP of the plurality of beams associated with the model. Then, the terminal device determines a target model. The target model is determined based on the plurality of RSRP differences from the plurality of models.

In this way, an appropriate model may be determined flexibly and efficiently by comparing quality information of multiple models at the same time, such that the determination being more efficient and flexible. As such, transmission performance may be improved based on use of the appropriate model.

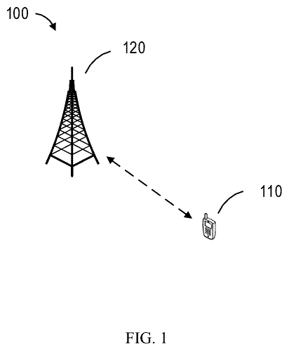

FIG. 1 illustrates an example environment 100 in which example embodiments of the present disclosure can be implemented.

The environment 100, which may be a part of a communication network, comprises a terminal device 110 and a network device 120. The terminal device 120 may communicate with the network device 110. In the communication system 100, a link from the network device 120 to a terminal device 110 is referred to as a downlink (DL), while a link from a terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

It is to be understood that the number of terminal devices and network device is shown in the environment 100 only for the purpose of illustration, without suggesting any limitation to the scope of the present disclosure. In some embodiments, the environment 100 may comprise a further terminal device to communicate information with a further network device.

Communications in the environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

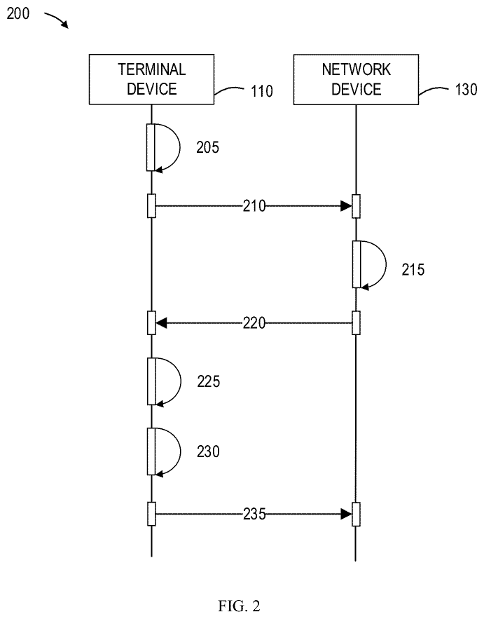

FIG. 2 illustrates a signaling process for model selection for CSI feedback between the network device and the terminal device according to some embodiments of the present disclosure. For purpose of discussion, the flowchart 200 will be described with reference to FIG. 1.

In some embodiments, the network device 120 may transmit to the terminal device 110 information about multiple encoding models trained for CSI feedback. The encoding model corresponds to a decoding model. The encoding model and the decoding model may be also referred to a first model and a second model, where output of the first model is input of the second model. The first model may be as same as or different from the second model. Then, the terminal device 110 may need to make a selection from the multiple trained encoding models to process CSI.

In some embodiments, the network device 120 may trigger a CSI report for model selection. For example, the network device 120 may transmit to the terminal device 110 an indication (also referred to as a first indication) for a CSI report for model selection. Then, the terminal device 110 may determine, based on information indicating that the CSI report is for model selection comprised in the first indication, that information associated with CSI for model selection need to be reported to the network device 120. For example, the information indicating that the CSI report is for model selection may be configured in CSI-ReportConfig or CSI trigger state (such as, CSI-AperiodicTriggerState or CSI-SemiPersistentOnPUSCH-TriggerState) associated the CSI report by a control signaling. Otherwise, if there is no information indicating that the CSI report is for model selection in the first indication, the terminal device 110 may only need to report information associated with CSI processed by one pre-determined encoding model.

Alternatively, the terminal device 110 may receive, from the network device 120, an second indication (also referred to as a second indication) for enabling model selection is to be transmitted. For example, the second indication may be a radio resource control (RRC) signaling, or a media access control-control element (MAC-CE), or downlink control information (DCI). Then, the terminal device 110 may receive a first indication for the CSI report after the reception of the second indication, thus the terminal device 110 may determine that the first indication for the CSI report is for model selection.

Alternatively, the terminal device 110 may receive, from the network device 120, an indication (also referred to as a third indication) for a duration for model selection. For example, the third indication may be a RRC signaling, or a MAC-CE or DCI. Then, if the terminal device 110 receives a first indication for a CSI report during the duration, it may determine that the first indication for the CSI report is for model selection.

In some embodiments, the terminal device 110 may make the model selection from some of the multiple encoding models. In this case, the terminal device 110 may first determine a plurality of encoding models to be considered for the CSI feedback.

The plurality of encoding models may be determined in a variety of approaches. For example, the terminal device 110 may determine the plurality of encoding models associated with the CSI report based on an explicit indication, for example, model information comprised in the first indication. For example, the model information may comprise a plurality of model indicators (such as model indexes or model identifiers). As another example, the encoding models may be pre-grouped. Then the model information may comprise a model group indicator. Alternatively, the model information may comprise one model indicator. Then, the terminal device 110 may determine a model group to which an encoding model having the model indicator belongs, and on this basis, the terminal device 110 may determine all encoding models in the model group to be considered for CSI feedback.

Alternatively, the terminal device 110 may determine the plurality of encoding models associated with the CSI report based on an implicit indication. In this case, the terminal device 110 may determine the plurality of encoding models associated with the CSI report based on CSI setting comprised in the first indication. For example, the CSI setting may comprise at least one of: a report quantity, a type of codebook, a bandwidth of downlink bandwidth part, a frequency granularity of a channel quality indicator, a pre-coding matrix indicator comprised in the first indication.

Alternatively, the terminal device 110 may determine the plurality of encoding models associated with the CSI report based on the above explicit indication and implicit indication. For example, the terminal device 110 may first determine a set of encoding models based on an above explicit indication. Then, in some cases, for example, in a model update procedure, the terminal device 110 may further determine a subset from the set of encoding models based on an above explicit indication.

In some embodiments, the network device 120 may transmit one or more CSI reference signals (CSI-RS) to the terminal device 110. Then, the terminal device 110 may obtain CSI based on the CSI-RS. For example, the CSI may comprise one of: a channel quality indicator, a pre-coding matrix indicator, a modulation and coding scheme, or a channel response.

As shown in FIG. 2, the terminal device 110 generates (205) a plurality of encoded CSI based on the CSI and the plurality of encoding models determined as above. For example, the encoded CSI may refer to binary bit information obtained by using an AI/ML model to compress a channel response or information or an eigenvector measured by the CSI-RS.

Then, the terminal device 110 transmits (210) the plurality of encoded CSI to the network device 120. For example, as a response to the first indication for the CSI report, the plurality of encoded CSI may be comprised in the quantity information of the CSI report. As an example, the plurality of encoded CSI may be transmitted in allocated physical uplink control channel (PUCCH) resource to the network device 120. Alternatively, the plurality of encoded CSI may be transmitted in uplink control information (UCI).

For example, a bitwidth for transmitting the plurality of encoded CSI may be determined at least based on sizes of the plurality of encoded CSI. For example, the number of central processing units (CPU) for processing the CSI report depends only on the number of CSI-RS resources, not the number of encoding models associated with the CSI report.

In some example, a CSI report carrying the plurality of encoded CSI may be transmitted with a highest priority than other CSI reports. In some embodiments where the appropriate encoding model has been configured at the terminal device 110, a CSI report carrying encoded CSI may be reported with the same priority as the other CSI reports, for example a CSI report carrying a CSI-RS resource indicator (CRI), a rank indication (RI), a layer indicator (LI), a precoding matrix indicator (PMI), or a channel quality indicator (CQI) etc. But it has lower priority than a beam report, that is, a CSI report carrying layer 1 reference signal received power (L1-RSRP) or L1 signal to interference plus noise ratio (L1-SINR).

In some embodiments, the plurality of encoded CSI may be transmitted in one of: an ascending order of model indexes of the plurality of encoding models; a descending order of model indexes of the plurality of encoding models; an ascending order of sizes of the encoded CSI; or a descending order of sizes of the encoded CSI.

The network device 120 generates (215) a plurality of recovered CSI based on the plurality of encoded CSI and a plurality of decoding models. The plurality of decoding models corresponding to the plurality of encoding models. The recovered CSI may refer to information output by the decoding model whose input is the encoded CSI.

The network device 120 transmits (220) the plurality of recovered CSI to the terminal device 110.

In some embodiments, the network device 120 may transmit the plurality of recovered CSI to the terminal device 110 in downlink control information (DCI). In this case, a new DCI format for model selection may be used to transmit the plurality of recovered CSI. The new DCI format may be scrambled by a pre-defined radio network tempory identity (RNTI). This DCI used to transmit the plurality of recovered CSI is similar to a DCI for scheduling of physical uplink share channel (PUSCH) (for example, DCI formats 0_0 and 0_1). The size of the DCI used to transmit the plurality of recovered CSI may be consistent with that of the DCI 0_0 or 0_1 to meet the restriction on the size of a DCI load. In this case, if the size of the DCI used to transmit the plurality of recovered CSI is not consistent with that of the DCI 0_0 or 0_1, the information bits in this DCI may need to be zero-padded or truncated.

In some embodiments, the plurality of recovered CSI may be transmitted in an ascending order of model indexes of the plurality of encoding models or a descending order of model indexes of the plurality of encoding models.

In some embodiments, the recovered CSI may be indicated in a new field in the DCI. Thus, the CSI indicated by the new field in the DCI refers to the recovered CSI. For example, in the embodiments where the CSI comprises a MCS or a PMI, the MCS or PMI may be different from the MCS or PMI applied for transmitting the scheduled PUSCH and indicated by the existing MCS or PMI field in the DCI. For example, the number of new fields used to carry the plurality of recovered CSI may be determined based on the number of the plurality of recovered CSI. At least one of the CQI field, new MCS field and new PMI field may needed to be indicated.

In some embodiments, the plurality of recovered CSI may be transmitted in a differential manner. For example, in the embodiments where the CSI comprises a MCS, the plurality of recovered MCS may be indicated with a difference between the recovered MCS and the MCS applied for the scheduled PUSCH. As another example, in the embodiments where the CSI comprises a CQI, the recovered CQI after the first recovered CQI may be indicated with a difference between the recovered CQI and the first recovered CQI.

In some embodiments, there is a need for the terminal device 110 to determine which encoding models that the plurality of indicated recovered CSI correspond to, that is, which models need to be performed model selection. For example, the terminal device 110 may determine a correspondence between the plurality of encoding models and the plurality of recovered CSI based on model information comprised in the DCI. For example, the model information may comprise a plurality of model indicators, or a model group indicator, or one model indicator for determination of encoding models in a model group comprising the model indicator. As an example, the DCI may comprise multiple model fields used to carry the plurality of model indicators. For example, the order of the multiple model fields may be as follows: an ascending or descending order of model indexes. As an example. the DCI may comprise a model group field used to carry a model group indicator. As another example, the DCI may comprise one model field used to carry one model indicator. Then, the terminal device 110 may determine a model group to which the model indicator belongs, and on this basis, the terminal device 110 may determine all encoding models in the model group as the encoding models corresponding to the plurality of indicated recovered CSI.

In some embodiments, the terminal device 110 may determine a correspondence between the plurality of encoding models and the plurality of recovered CSI based on a CSI report associated with a CSI report indicator comprised in the DCI. In this case, the CSI may comprise a CSI report indicator field. This field may indicate the CSI report associated with the encoding models associated with the indicated CSI. Then, the encoding models may be determined based on the models associated with the indicated CSI report.

In some embodiments, the terminal device 110 may determine a correspondence between the plurality of encoding models and the plurality of recovered CSI based on a CSI report associated with a CSI trigger state comprised in the DCI. In this case, the terminal device 110 may reuse a “CSI request” field. The field is only used to determine the encoding models associated with the CSI report associated with the indicated CSI trigger state. The UE may drop or omit this CSI trigger state in the DCI.

In some embodiments, the terminal device 110 may determine a correspondence between the plurality of encoding models and the plurality of recovered CSI based on a plurality of encoding models associated with a previous CSI report having a smallest time interval with the DCI. In this case, the plurality of encoding models corresponding to the plurality of recovered CSI may be determined as the encoding models associated with the recent CSI report.

In some embodiments, the terminal device 110 may determine a correspondence between the CSI-RS and the plurality of recovered CSI based on a CSI report associated with a CSI report indicator, or based on a CSI report associated with a CSI trigger state comprised in the DCI. In this case, the CSI-RS corresponding to the plurality of recovered CSI may be determined as the CSI-RS associated with the indicated CSI report. As such, the terminal device 110 may determine the encoding models and the CSI-RS at the same time.

In some embodiments, the terminal device 110 may determine a correspondence between the CSI-RS and the plurality of recovered CSI based on a CSI-RS associated with a previous CSI report having a smallest time interval with the DCI. In this case, the CSI-RS corresponding to the plurality of recovered CSI may be determined as the CSI-RS associated with the recent CSI report.

Alternatively or in addition, the network device 120 may trigger a further CSI report. In this case, the network device 120 may transmit the plurality of recovered CSI to the terminal device 110 in an indication (also referred as a fourth indication) for the further CSI report. Accordingly, the terminal device 110 may obtain the plurality of recovered CSI from the fourth indication for the further CSI report. For example, the fourth indication for the further CSI report may comprise information indicating that the further CSI report is for model selection.

In some embodiments, the fourth indication may comprise model information, and then the terminal device 110 may determine a correspondence between the plurality of encoding models and the plurality of recovered CSI based on the model information comprised in the fourth indication. For example, the model information may comprise a plurality of model indicators, or a model group indicator, or one model indicator for determination of encoding models in a model group comprising the model indicator. The determination approach for determining the association between the plurality of encoding models and the plurality of recovered CSI based on the model information comprised in the fourth indication is similar as the determination approach for determining the association between the plurality of encoding models and the plurality of recovered CSI based on the model information comprised in the DCI. To simplify the discussion, the details of the determination are omitted here.

In some embodiments, the terminal device 110 may determine a correspondence between the CSI-RS and the plurality of recovered CSI based on a CSI-RS associated with the further CSI report. The CSI report and the further CSI report may be associated with the same CSI-RS.

Alternatively or in addition, the terminal device 110 may determine a correspondence between the CSI-RS and the plurality of recovered CSI based on a CSI-RS associated with a previous CSI report having a smallest time interval with the further CSI report. In this case, the terminal device 110 may determine the CSI-RS corresponding to the plurality of recovered CSI as the CSI-RS associated with the recent CSI report.

Alternatively or in addition, the CSI report may be associated with the further CSI report. In this case, the terminal device 110 may determine a correspondence between the CSI-RS and the plurality of recovered CSI based on the CSI-RS associated with the CSI report associated with the further CSI report. As such, the terminal device 110 may determine the association between the plurality of encoding models and the plurality of recovered CSI models at the same time.

As shown in FIG. 2, the terminal device 110 determines (225) difference information of the plurality of encoding models based on the CSI and the plurality of recovered CSI. For example, the difference information may comprise model estimation accuracy (such as, generalized cosine similarity (GCS)) or estimation error (such as, CSI difference between the CSI and the recovered CSI) and the like. Alternatively, the difference information may comprise complexity or inference time of the model.

In some embodiments, the terminal device 110 may determine (230) a target encoding model from the plurality of encoding models based on the difference information. In this case, the target encoding model may be an appropriate encoding model determined by the terminal device 110 at least based on the difference information and some other performance indicators, such as the complexity and latency.

Then, the terminal device 110 may transmit (235) to the network device 120 an indication (also referred to as a sixth indication) for a target decoding model corresponding to the target encoding model. Accordingly the network device 120 may determine the target decoding model based on the sixth indication.

In the embodiments where the network device 120 transmits the plurality of recovered CSI to the terminal device 110 in the DCI, the terminal device 110 may transmit the sixth indication to the network device 120 in the PUSCH. In this case, for example, a new MAC-CE may be used to carry the information associated with the target decoding model.

In the embodiments where the network device 120 transmits the plurality of recovered CSI to the terminal device 110 in the fourth indication for further CSI report, the information associated with the target decoding model may be comprised in the quantity information of the further CSI report. For example, the bitwidth, the CPU and the priority rules may be determined similarly as described above.

Alternatively or in addition, the terminal device 110 may transmit the difference information of the plurality of encoding models to the network device 120. For example, the difference information may be transmitted in an ascending order of model indexes of the plurality of encoding models or a descending order of model indexes of the plurality of encoding models.

In the embodiments where the network device 120 transmits the plurality of recovered CSI to the terminal device 110 in the DCI, the terminal device 110 may transmit the difference information to the network device 120 in the PUSCH. In this case, for example, a new MAC-CE may be used to carry the difference information and model information. For example, the model information may comprise a plurality of model indicators, or a model group indicator, or one model indicator for determination of encoding models in a model group comprising the model indicator.

In the embodiments where the network device 120 transmits the plurality of recovered CSI to the terminal device 110 in the fourth indication for further CSI report, the difference information may be comprised in the quantity information of the further CSI report. For example, the bitwidth, the CPU and the priority rules may be determined similarly as described above.

Then, the network device 120 may determine, based on the difference information, a target decoding model from a plurality of decoding models corresponding to the plurality of encoding models. Further, the network device 120 may transmit to the terminal device 110 an indication (also referred to as a seventh indication) for the target encoding model corresponding to the target decoding model. Then, the terminal device 110 may determine the target encoding model based on the seventh indication.

In some embodiment, considering that model selection is used for model deployment, monitoring and update, periodic, semi-persistent or aperiodic model selection may be applied

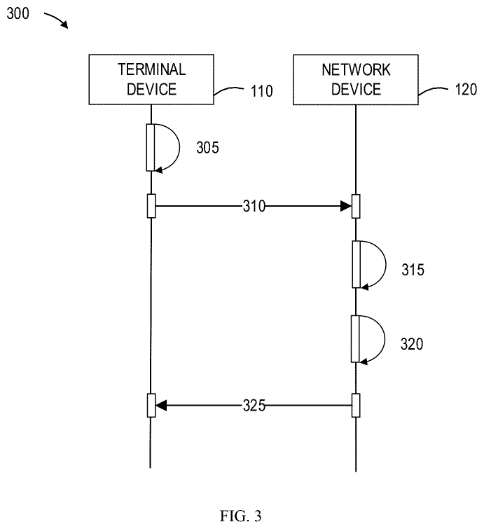

FIG. 3 illustrates a signaling process for model selection for CSI feedback between the network device and the terminal device according to some other embodiments of the present disclosure. For purpose of discussion, the flowchart 300 will be described with reference to FIG. 1.

In some example, terminal device 110 may obtain CSI based on a CSI-RS from the network device 120. For example, the CSI may comprise one of: a channel quality indicator, a pre-coding matrix indicator, a modulation and coding scheme, or a channel response.

As shown in FIG. 3, the terminal device 110 generates (305) a plurality of encoded CSI based on the CSI and a plurality of encoding models for CSI feedback.

Then, the terminal device 110 transmits (310), to the network device 120, the CSI and the plurality of encoded CSI. As an example, as a response to the first indication for the CSI report, the CSI and the plurality of encoded CSI may be comprised in the quantity information of the CSI report. For example, the plurality of encoded CSI may be transmitted in front of or behand the CSI. Accordingly, the network device 120 receives the plurality of encoded CSI and the CSI from the terminal device 110.

The network device 120 generates (315) a plurality of recovered CSI based on the plurality of encoded CSI and a plurality of decoding models corresponding to the plurality of encoding models. Then, the network device 120 determines difference information of the plurality of encoding models based on the CSI and the plurality of recovered CSI. For example, the difference information may comprise model estimation accuracy (such as, GCS) or estimation error (such as, CSI difference between the CSI and the recovered CSI) and the like. Alternatively, the difference information may comprise complexity or inference time of the model.

The network device 120 determines (320) a target decoding model from the plurality of decoding models based on the difference information. Then, the network device 120 transmits (325) to the terminal device 110 an indication (also referred to as an eighth indication) for a target encoding model corresponding to the target decoding mode. Accordingly, the terminal device 110 may determine the target encoding model based on the eighth indication.

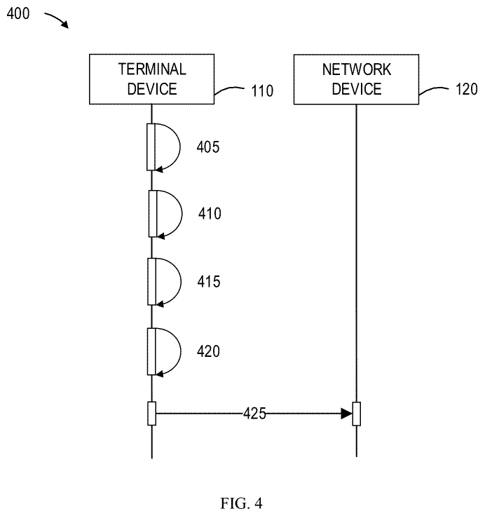

FIG. 4 illustrates a signaling process for model selection for CSI feedback between the network device and the terminal device according to some further embodiments of the present disclosure. For purpose of discussion, the flowchart 400 will be described with reference to FIG. 1.

In some embodiments, the terminal device 110 may obtain CSI based on a CSI-RS from the network device 120. For example, the CSI comprises one of: a channel quality indicator, a pre-coding matrix indicator, a modulation and coding scheme, or a channel response. Then, the terminal device 110 generates (405) a plurality of encoded CSI based a plurality of encoding models for CSI feedback and the CSI.

In some embodiments, the terminal device 110 may be configured with a plurality of decoding models corresponding to the plurality of encoding models. In this case, the terminal device 110 may transmit, to the network device 120, an indication (also referred to as a fifth indication) for support of the plurality of decoding models, or in other words, capability of the plurality of decoding models.

As shown in FIG. 4, the terminal device 110 generates (410) a plurality of recovered CSI based on the plurality of encoded CSI and the plurality of decoding models. Then, the terminal device 110 determines (415) difference information of the plurality of encoding models based on the CSI and the plurality of recovered CSI. For example, the difference information may comprise model estimation accuracy (such as, GCS) or estimation error (such as, CSI difference between the CSI and the recovered CSI) and the like. Alternatively, the difference information may comprise complexity or inference time of the model.

In some embodiments, the terminal device 110 may determine (420) a target encoding model based on the difference information of the plurality of encoding models. Then, the terminal device 110 may transmit (425), to the network device 120, a sixth indication for a target decoding model corresponding to the target encoding model.

Alternatively or in addition, the terminal device 110 may transmit the difference information to the network device 120. For example, difference information of the plurality of encoding models may be transmitted in an ascending order of model indexes of the plurality of encoding models or a descending order of model indexes of the plurality of encoding models.

Then, the network device 120 may determine a target decoding model from the plurality of decoding models based on the difference information. Further, the network device 120 may transmit a seventh indication for the target encoding model.

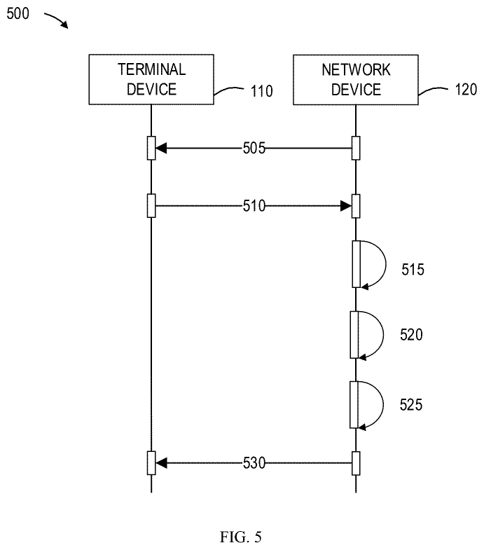

FIG. 5 illustrates a signaling process for model selection for beam prediction between the network device and the terminal device according to some embodiments of the present disclosure. For purpose of discussion, the flowchart 500 will be described with reference to FIG. 1.

As shown in FIG. 5, the network device 120 transmits (505) to the terminal device 110, an indication (also referred to as a ninth indication) for a CSI report for model selection for beam prediction. For example, the beam prediction may comprise beam prediction in spatial or time domain. For example, the beam used herein may refer to CSI-RS resources associated with the CSI report or a QCL typed RS associated with CSI-RS resources associated with the CSI report. For example, the ninth indication may comprise information indicating a plurality of beams to be reported. Then, the network device 120 may transmit CSI-RS to the terminal device 110.

The terminal device 110 may obtain RSRP of the plurality of beam. Then, the terminal device 110 transmits (510) the RSRP of the plurality of beams to the network device 120. For example, the RSRP of the plurality of beams may be transmitted with a differential manner. In this case, the terminal device 110 may only need to transmit the RSRP of the plurality of beams and there is no need to transmit beam indexes of the plurality of beams, for the reason that the order of the reported RSRP may follow the beam identifiers (ID), for example, CRIs or a synchronization signal block RIs (SSBRI).

The network device 120 obtains (515), for each model of a plurality of models for beam prediction, processed RSRP of a plurality of beams based on the model and RSRP of a subset of the plurality of beams associated with the model. A different model corresponds to a different beam combination.

The network device 120 determines (520) for each model of the plurality of models, a RSRP difference based on the RSRP of the plurality of beams and the processed RSRP of the plurality of beams associated with the model.

Then, the network device 120 determines (525) a target model from the plurality of models based on a plurality of RSRP differences associated with the plurality of models.

Then, the network device 120 transmits (530), to the terminal device 110, an indication (also referred to as a tenth indication) for a beam combination associated with the target model. The beam combination is a subset of the plurality of beams.

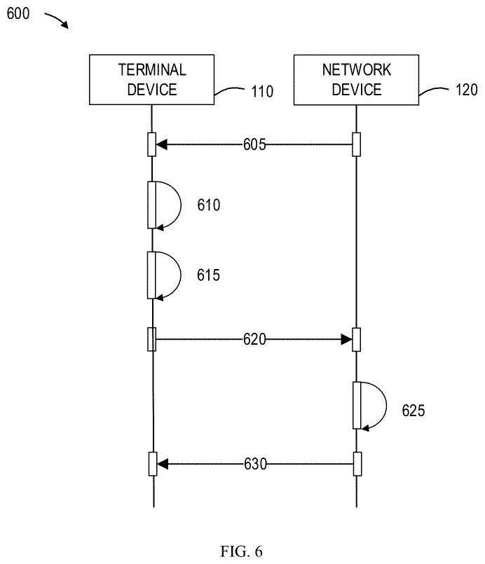

FIG. 6 illustrates a signaling process for model selection for beam prediction between the network device and the terminal device according to some other embodiments of the present disclosure. For purpose of discussion, the flowchart 600 will be described with reference to FIG. 1.

As shown in FIG. 6, the network device 120 transmits (605), to the terminal device 110, an indication (also referred to as an eleventh indication) for a CSI report for model selection for beam prediction. For example, a different model corresponding to a different beam combination. Then, the network device 120 may transmit CSI-RS to the terminal device 110.

The terminal device 110 may obtain RSRP of the plurality of beam. Then, the terminal device 110 obtains (610), for each model of a plurality of models for beam prediction, processed RSRP of the plurality of beams based on the model and RSRP of a subset of the plurality of beams associated with the model.

Then, the terminal device 110 determines (615), for each model of the plurality of models, a RSRP difference based on the RSRP of the plurality of beams and the processed RSRP of the plurality of beams associated with the model. For example, the RSRP difference associated with individual model may be an averaged RSRP difference, which is averaged based on the number of the plurality of beams.

In some embodiments, the terminal device 110 may transmit (620) to the network device 120 a plurality of RSRP differences associated with the plurality of models. For example, as a response to the eleventh indication for the CSI report, the plurality of plurality of RSRP differences associated with the plurality of models may be comprised in the quantity information of the CSI report. Foer example, differential reporting may be applied. The network device 120 may determine (625) a target model from the plurality of models based on the plurality of RSRP differences associated with the plurality of models. Then, the network device 120 transmit (630), to the terminal device 110, an indication (also referred to as a twelfth indication) for the target model. Alternatively or in addition, the twelfth indication may indicate a beam combination associated with the target model. Accordingly, the terminal device 110 may determine the target model based on the twelfth indication.

In some embodiments, the terminal device 110 may determine the target model from the plurality of models based on the plurality of RSRP differences associated with the plurality of models. Then, the terminal device 110 may transmit, to the network device 120, an indication (also referred to as a thirteenth indication) for the target model. Alternatively or in addition, the thirteenth indication may indicate a beam combination associated with the target model. For example, the thirteenth indication may comprise beam ID, such as CRI or SSBRI. As an example, in this case, the bitwidth may be determined based on the number of CSI-RS resources and the number of beams corresponding to the models. For example, assuming that the CSI report has 24 CSI-RS resources, and if the number of beams corresponding to the models is 4, the bitwidth may be calculated as 5 bits * 4=20 bits. Accordingly, the network device 120 may determine the target model based on the thirteenth indication.

In some embodiments, the terminal device 110 may first determine a model subset of all models deployed at the terminal device 110, and then determine one from the model subset. For example, the eleventh indication may comprise information associated with a plurality of CSI-RSs. In this case, the terminal device 110 may determine the plurality of models based on the CSI-RSs associated with the beam report. Further, the number of beams may correspond to the certain models. Therefore, the eleventh indication may comprise information used to indicate the number of beams corresponding to the input of the models. Then, the terminal device 110 may determine the plurality of models based on this information used to indicate the number of beams.

In some embodiments, if model selection is for the models having the same number of beams and different beam combinations, the network device 120 may not determine which model is best. In this case, the terminal device 110 may transmit to the network device 120 both RSRP and model ID. For example, up to a maximum number of best models may be reported. The maximum number may depend on the capability of the terminal device 110. For example, differential reporting may be applied.

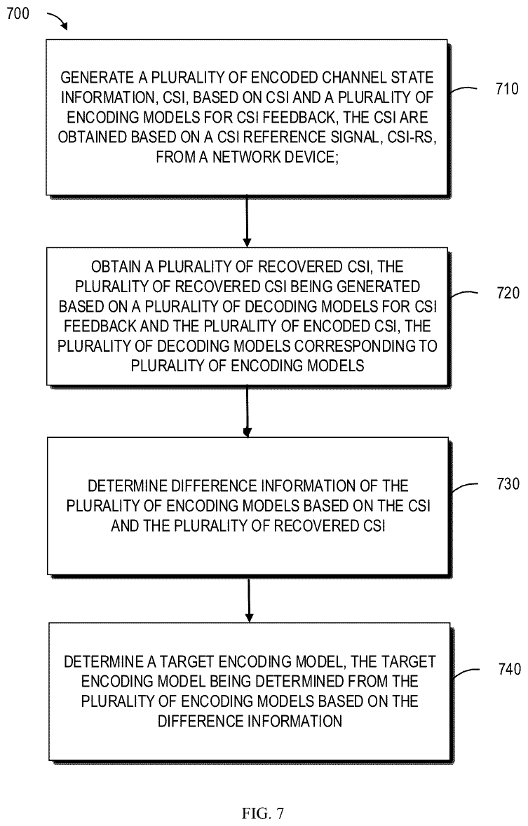

FIG. 7 illustrates a flowchart of an example method 700 of communication implemented at a terminal device in accordance with some embodiments of the present disclosure. The method 700 can be implemented at the terminal device 110 shown in FIG. 1. For the purpose of discussion, the method 700 will be described with reference to FIG. 1. It is to be understood that the method 700 may include additional acts not shown and/or may omit some shown acts, and the scope of the present disclosure is not limited in this regard.

At block 710, the terminal device 110 generates a plurality of encoded channel state information, CSI, based on CSI and a plurality of encoding models for CSI feedback, the CSI being obtained based on a CSI reference signal, CSI-RS, from the network device 120. At block 720, the terminal device 110 obtains a plurality of recovered CSI, the plurality of recovered CSI being generated based on a plurality of decoding models for CSI feedback and the plurality of encoded CSI, the plurality of decoding models corresponding to the plurality of encoding models. At block 730, the terminal device 110 determines difference information of the plurality of encoding models based on the CSI and the plurality of recovered CSI. At block 740, the terminal device 110 determines a target encoding model, the target encoding model being determined from the plurality of encoding models based on the difference information.

In some embodiments, the terminal device 110 may receive, from the network device 120, a first indication for a CSI report for model selection, wherein the first indication comprises information indicating that the CSI report is for model selection.

In some embodiments, the terminal device 110 may receive, from the network device 120, a second indication for enabling model selection; and in response to receiving a first indication for the CSI report after the reception of the second indication, determine that the first indication for the CSI report is for model selection.

In some embodiments, the terminal device 110 may receive, from the network device 120, a third indication for a duration for model selection; and in response to receiving a first indication for a CSI report during the duration, determine that the first indication for the CSI report is for model selection.

In some embodiments, the terminal device 110 may determine the plurality of encoding models based on at least one of: model information comprised in the first indication; or CSI setting comprised in the first indication.

In some embodiments, the model information may comprise one of: a plurality of model indicators; a model group indicator, or one model indicator for determination of encoding models in a model group comprising the model indicator.

In some embodiments, the terminal device 110 may transmit the plurality of encoded CSI to the network device 120; and the terminal device 110 may receive the plurality of recovered CSI from the network device 120.

In some embodiments, a bitwidth for transmitting the plurality of encoded CSI may be determined at least based on sizes of the plurality of encoded CSI.

In some embodiments, a CSI report carrying the plurality of encoded CSI may be transmitted with a highest priority than other CSI reports.

In some embodiments, the plurality of encoded CSI may be transmitted in one of: an ascending order of model indexes of the plurality of encoding models; a descending order of model indexes of the plurality of encoding models; an ascending order of sizes of the encoded CSI; or a descending order of sizes of the encoded CSI.

In some embodiments, the terminal device 110 may receive, from the network device 120, the plurality of recovered CSI in a downlink control information, DCI.

In some embodiments, the DCI may use a DCI format scrambled by a pre-defined radio network tempory identity (RNTI).

In some embodiments, the terminal device 110 may determine a correspondence between the plurality of encoding models and the plurality of recovered CSI based on model information comprised in the DCI, the model information comprising a plurality of model indicators, or a model group indicator, or one model indicator for determination of encoding models in a model group comprising the model indicator.

In some embodiments, the terminal device 110 may determine a correspondence between the plurality of encoding models and the plurality of recovered CSI based on a CSI report associated with a CSI report indicator comprised in the DCI, or based on a CSI report associated with a CSI trigger state comprised in the DCI.

In some embodiments, the terminal device 110 may determine a correspondence between the plurality of encoding models and the plurality of recovered CSI based on a plurality of encoding models associated with a previous CSI report having a smallest time interval with the DCI.

In some embodiments, the terminal device 110 may determine a correspondence between the CSI-RS and the plurality of recovered CSI based on a CSI report associated with a CSI report indicator, or based on a CSI report associated with a CSI trigger state comprised in the DCI.

In some embodiments, the terminal device 110 may determine a correspondence between the CSI-RS and the plurality of recovered CSI based on a CSI-RS associated with a previous CSI report having a smallest time interval with the DCI.

In some embodiments, the terminal device 110 may receive, from the network device 120, the plurality of recovered CSI in a fourth indication for a further CSI report; and obtain the plurality of recovered CSI from the fourth indication for the further CSI report.

In some embodiments, the fourth indication for the further CSI report may comprise information indicating that the further CSI report is for model selection.

In some embodiments, the terminal device 110 may determine a correspondence between the plurality of encoding models and the plurality of recovered CSI based on model information comprised in the fourth indication, the model information comprising a plurality of model indicators, or a model group indicator, or one model indicator for determination of encoding models in a model group comprising the model indicator.

In some embodiments, the terminal device 110 may determine a correspondence between the CSI-RS and the plurality of recovered CSI based on a CSI-RS associated with the further CSI report.

In some embodiments, the CSI report and the further CSI report may be associated with the same CSI-RS.

In some embodiments, the terminal device 110 may determine a correspondence between the CSI-RS and the plurality of recovered CSI based on a CSI-RS associated with a previous CSI report having a smallest time interval with the further CSI report.

In some embodiments, the CSI report may be associated with the further CSI report, and the terminal device 110 may determine a correspondence between the CSI-RS and the plurality of recovered CSI based on the CSI-RS associated with the CSI report associated with the further CSI report.

In some embodiments, the terminal device 110 may be configured the plurality of decoding models, and the terminal device 110 may generate the plurality of recovered CSI based on the plurality of encoded CSI and the plurality of decoding models.

In some embodiments, the terminal device 110 may transmit, to the network device 120, a fifth indication for support of the plurality of decoding models.

In some embodiments, the terminal device 110 may determine the target encoding model based on the difference information; and transmit, to the network device 120, a sixth indication for a target decoding model, the target decoding model corresponding to the target encoding model.

In some embodiments, the terminal device 110 may transmit the difference information to the network device 120; and receive, from the network device 120, a seventh indication for the target encoding model. The terminal device 110 may determine the target encoding model based on the seventh indication.

In some embodiments, the difference information may be transmitted in one of: an ascending order of model indexes of the plurality of encoding models or a descending order of model indexes of the plurality of encoding models.

In some embodiments, the CSI may comprise one of: a channel quality indicator, a pre-coding matrix indicator, a modulation and coding scheme, or a channel response.

Those skilled in the art can understand that all operations and features as described above with reference to FIGS. 2 and 4 are likewise applicable to the method 700 and have similar effects.

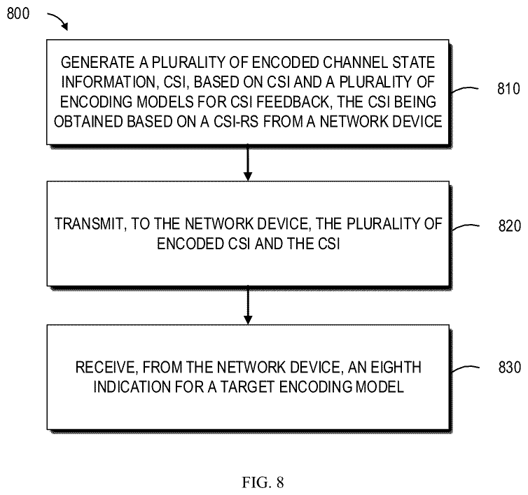

FIG. 8 illustrates a flowchart of a method 800 of communication implemented at a terminal device in accordance with some embodiments of the present disclosure. The method 800 can be implemented at the terminal device 110 shown in FIG. 1. For the purpose of discussion, the method 800 will be described with reference to FIG. 1. It is to be understood that the method 800 may include additional acts not shown and/or may omit some shown acts, and the scope of the present disclosure is not limited in this regard.

At block 810, the terminal device 110 generates a plurality of encoded channel state information, CSI, based on CSI and a plurality of encoding models for CSI feedback, the CSI being obtained based on a CSI-RS from the network device 120. At block 820, the terminal device 110 transmits, to the network device 120, the plurality of encoded CSI and the CSI. At block 830, the terminal device 110 receives, from the network device 120, an eighth indication for a target encoding model.

In some embodiments, the plurality of encoded CSI may be transmitted in front of or behand the CSI.

Those skilled in the art can understand that all operations and features as described above with reference to FIG. 3 are likewise applicable to the method 800 and have similar effects.

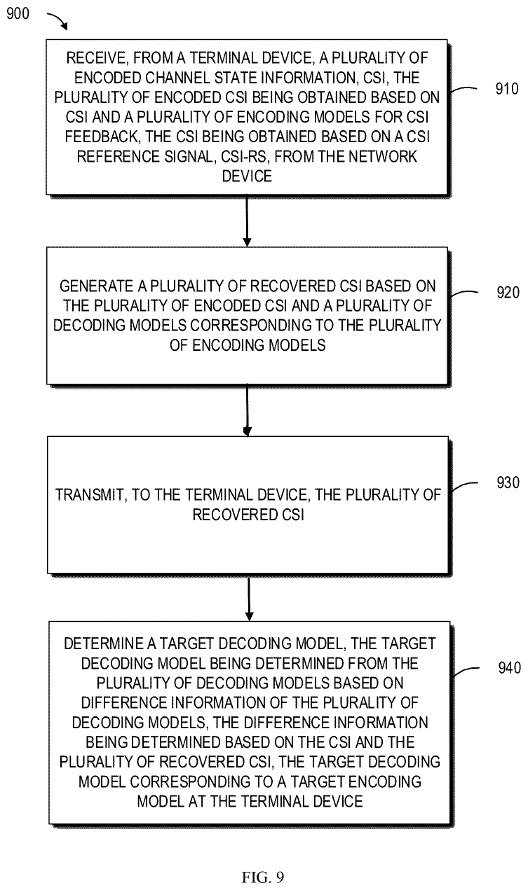

FIG. 9 illustrates a flowchart of a method 900 of communication implemented at a network device in accordance with some embodiments of the present disclosure. The method 900 can be implemented at the network device 120 shown in FIG. 1. For the purpose of discussion, the method 900 will be described with reference to FIG. 1. It is to be understood that the method 900 may include additional acts not shown and/or may omit some shown acts, and the scope of the present disclosure is not limited in this regard.

At block 910, the network device 120 receives, from a terminal device 110, a plurality of encoded channel state information, CSI, the plurality of encoded CSI being obtained based on CSI and a plurality of encoding models for CSI feedback, the CSI being obtained based on a CSI reference signal, CSI-RS, from the network device. At block 920, the network device 120 generates a plurality of recovered CSI based on the plurality of encoded CSI and a plurality of decoding models corresponding to the plurality of encoding models. At block 930, the network device 120 transmits, to the terminal device 110, the plurality of recovered CSI. At block 940, the network device 120 determines a target decoding model, the target decoding model being determined from the plurality of decoding models based on difference information of the plurality of decoding models, the difference information being determined based on the CSI and the plurality of recovered CSI, the target decoding model corresponding to a target encoding model at the terminal device 110.

In some embodiments, the network device 120 may transmit, to the terminal device 110, a first indication for a CSI report for model selection, the first indication for the CSI report comprises information indicating that the CSI report is for model selection.

In some embodiments, the network device 120 may transmit to the terminal device 110, a second indication for enabling model selection; and transmit, to the terminal device 110, a first indication for a CSI report for model selection after the transmission of the second indication.

In some embodiments, the network device 120 may transmit, to the terminal device 110 a third indication for a duration for model selection; and transmit, to the terminal device 110, a first indication for a CSI report for model selection during the duration.

In some embodiments, the network device 120 may transmit, to the terminal device 110, the plurality of recovered CSI in a downlink control information, DCI.

In some embodiments, the DCI may use a DCI format scrambled by a pre-defined radio network tempory identity (RNTI).

In some embodiments, the DCI may comprise model information for indicating a correspondence between the plurality of encoding models and the plurality of recovered CSI, the model information comprising a plurality of model indicators, or a model group indicator, or one model indicator for determination of encoding models in a model group comprising the model indicator.

In some embodiments, the DCI may comprise a CSI report indicator or a CSI trigger state for indicating at least one of: a correspondence between the plurality of encoding models and the plurality of recovered CSI; or a correspondence between the CSI-RS and the plurality of recovered CSI.

In some embodiments, the network device 120 may transmit, to the terminal device 110, the plurality of recovered CSI in a fourth indication for a further CSI report.

In some embodiments, the fourth indication for the further CSI report may comprise information indicating that the further CSI report is for model selection.

In some embodiments, the fourth indication for the further CSI report may comprise model information for indicating a correspondence between the plurality of encoding models and the plurality of recovered CSI, the model information comprising a plurality of model indicators, or a model group indicator, or one model indicator for determination of encoding models in a model group comprising the model indicator.

In some embodiments, the plurality of recovered CSI may be transmitted in an ascending order of model indexes of the plurality of decoding models or a descending order of model indexes of the plurality of decoding models.

In some embodiments, the plurality of recovered CSI may be transmitted with a differential manner.

In some embodiments, the network device 120 may receive, from the network device 110, a sixth indication for the target decoding model, and determine the target decoding model based on the sixth indication.

In some embodiments, the network device 120 may receive from the terminal device 110, the difference information; and determine the target decoding model based on the difference information.

In some embodiments, the network device 120 may transmit, to the terminal device 110, a seventh indication for the target encoding model, the target encoding model corresponding to the target decoding model.

Those skilled in the art can understand that all operations and features as described above with reference to FIGS. 2 and 4 are likewise applicable to the method 900 and have similar effects.

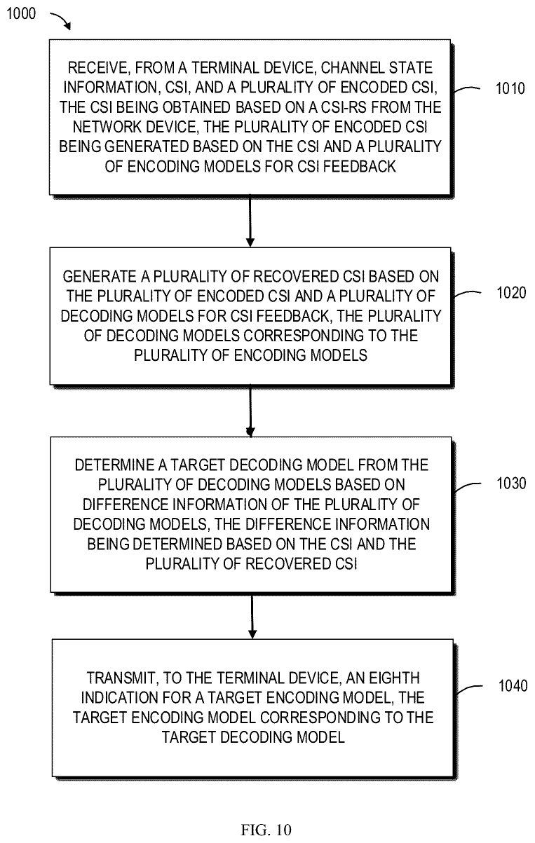

FIG. 10 illustrates a flowchart of a method 1000 of communication implemented at a network device in accordance with some embodiments of the present disclosure. The method 1000 can be implemented at the network device 120 shown in FIG. 1. For the purpose of discussion, the method 1000 will be described with reference to FIG. 1. It is to be understood that the method 1000 may include additional acts not shown and/or may omit some shown acts, and the scope of the present disclosure is not limited in this regard.

At block 1010, the network device 120 receives, from the terminal device 110, channel state information, CSI, and a plurality of encoded CSI, the CSI being obtained based on a CSI-RS from the network device 120, the plurality of encoded CSI being generated based on the CSI and a plurality of encoding models for CSI feedback. At block 1020, the network device 120 generates a plurality of recovered CSI based on the plurality of encoded CSI and a plurality of decoding models for CSI feedback, the plurality of decoding models corresponding to the plurality of encoding models. At block 1030, the network device 120 determine a target decoding model from the plurality of decoding models based on difference information of the plurality of decoding models, the difference information being determined based on the CSI and the plurality of recovered CSI. At block 1040, the network device 120 transmits, to the terminal device 110, an eighth indication for a target encoding model, the target encoding model corresponding to the target decoding model.

In some embodiments, the plurality of encoded CSI may be received in front of or behand the CSI.

Those skilled in the art can understand that all operations and features as described above with reference to FIG. 3 are likewise applicable to the method 1000 and have similar effects.

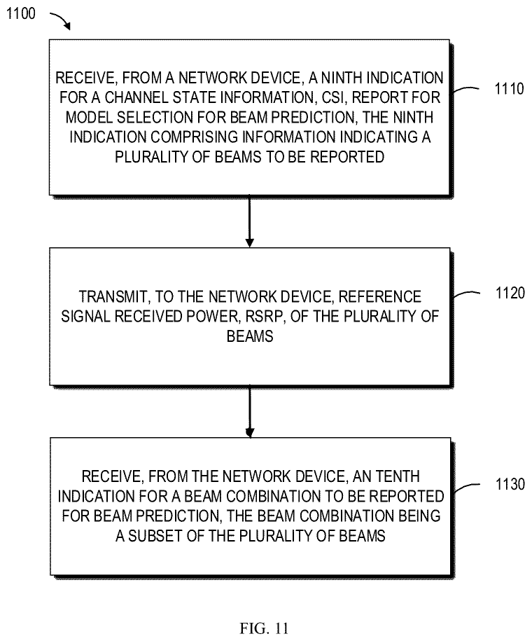

FIG. 11 illustrates a flowchart of a method 1100 of communication implemented at a terminal device in accordance with some embodiments of the present disclosure. The method 1100 can be implemented at the terminal device 110 shown in FIG. 1. For the purpose of discussion, the method 1100 will be described with reference to FIG. 1. It is to be understood that the method 1100 may include additional acts not shown and/or may omit some shown acts, and the scope of the present disclosure is not limited in this regard.

At block 1110, the terminal device 110 receives, from the network device 120, a ninth indication for a channel state information, CSI, report for model selection for beam prediction, the ninth indication comprising information indicating a plurality of beams to be reported. At block 1120, the terminal device 110 transmits, to the network device 120, reference signal received power, RSRP, of the plurality of beams. At block 1130, the terminal device 110 receives, from the network device 120, a tenth indication for a beam combination to be reported for beam prediction, the beam combination being a subset of the plurality of beams.

Those skilled in the art can understand that all operations and features as described above with reference to FIG. 5 are likewise applicable to the method 1100 and have similar effects.

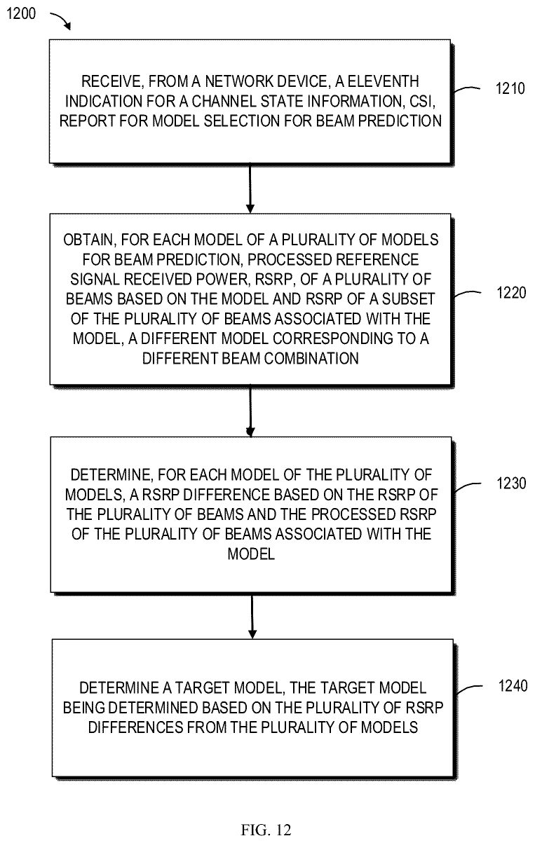

FIG. 12 illustrates a flowchart of a method 1200 of communication implemented at a terminal device in accordance with some embodiments of the present disclosure. The method 1200 can be implemented at the terminal device 110 shown in FIG. 1. For the purpose of discussion, the method 1200 will be described with reference to FIG. 1. It is to be understood that the method 1200 may include additional acts not shown and/or may omit some shown acts, and the scope of the present disclosure is not limited in this regard.

At block 1210, the terminal device 110 receives, from a network device 120, a eleventh indication for a channel state information, CSI, report for model selection for beam prediction. At block 1220, the terminal device 110 obtains, for each model of a plurality of models for beam prediction, processed reference signal received power, RSRP, of a plurality of beams based on the model and RSRP of a subset of the plurality of beams associated with the model, a different model corresponding to a different beam combination. At block 1230, the terminal device 110 determines, for each model of the plurality of models, a RSRP difference based on the RSRP of the plurality of beams and the processed RSRP of the plurality of beams associated with the model. At block 1240, the terminal device 110 determines a target model, the target model being determined based on the plurality of RSRP differences from the plurality of models.

In some embodiments, the terminal device 110 may transmitting, to the network device 120, a plurality of RSRP differences associated with the plurality of models; receive, from the network device 120, a twelfth indication for the target model or a beam combination associated with the target model; and determine the target model based on the twelfth indication.

In some embodiments, the terminal device 110 may determine the target model based on the plurality of RSRP differences associated with the plurality of models; and transmit, to the network device 120, a thirteenth indication for the target model, or a beam combination associated with the target model.

In some embodiments, the terminal device 110 may determine the plurality of models based on information associated with a plurality of CSI reference signals comprised in the eleventh indication.

Those skilled in the art can understand that all operations and features as described above with reference to FIG. 6 are likewise applicable to the method 1200 and have similar effects.

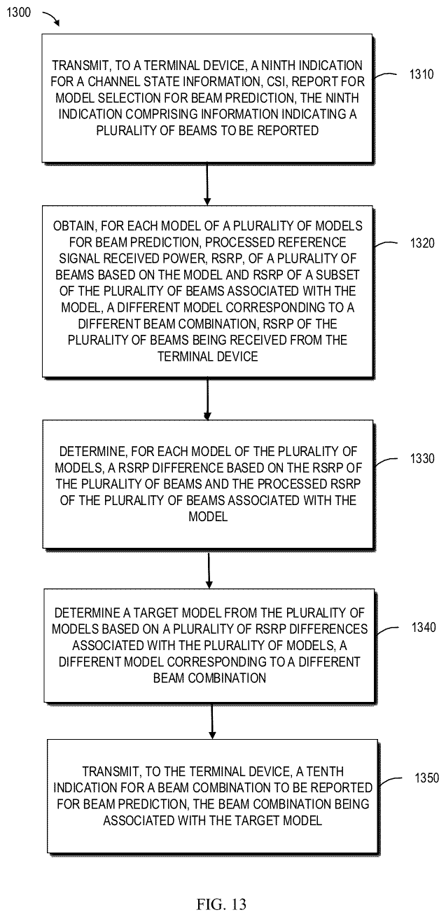

FIG. 13 illustrates a flowchart of a method 1300 of communication implemented at a network device in accordance with some embodiments of the present disclosure. The method 1300 can be implemented at the network device 120 shown in FIG. 1. For the purpose of discussion, the method 1300 will be described with reference to FIG. 1. It is to be understood that the method 1300 may include additional acts not shown and/or may omit some shown acts, and the scope of the present disclosure is not limited in this regard.

At block 1310, the network device 120 transmits, to a terminal device 110, a ninth indication for a channel state information, CSI, report for model selection for beam prediction, the ninth indication comprising information indicating a plurality of beams to be reported. At block 1320, the network device 120 obtains, for each model of a plurality of models for beam prediction, processed reference signal received power, RSRP, of a plurality of beams based on the model and RSRP of a subset of the plurality of beams associated with the model, a different model corresponding to a different beam combination, RSRP of the plurality of beams being received from the terminal device 110. At block 1330, the network device 120 determines, for each model of the plurality of models, a RSRP difference based on the RSRP of the plurality of beams and the processed RSRP of the plurality of beams associated with the model. At block 1340, the network device 120 determines a target model from the plurality of models based on a plurality of RSRP differences associated with the plurality of models, a different model corresponding to a different beam combination. At block 1350, the network device 120 transmits, to the terminal device 110, a tenth indication for a beam combination to be reported for beam prediction, the beam combination being associated with the target model.

Those skilled in the art can understand that all operations and features as described above with reference to FIG. 5 are likewise applicable to the method 1300 and have similar effects.

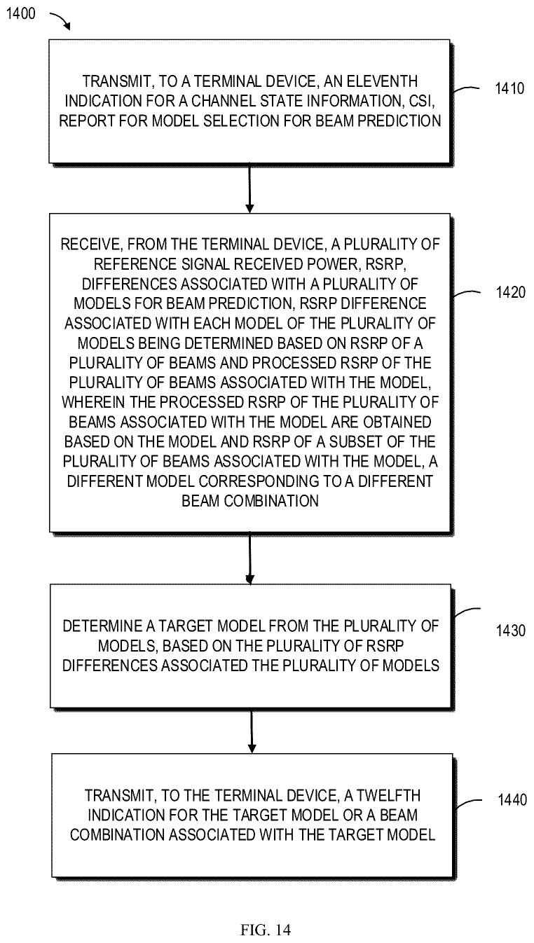

FIG. 14 illustrates a flowchart of a method 1400 of communication implemented at a network device in accordance with some embodiments of the present disclosure. The method 1400 can be implemented at the network device 120 shown in FIG. 1. For the purpose of discussion, the method 1400 will be described with reference to FIG. 1. It is to be understood that the method 1400 may include additional acts not shown and/or may omit some shown acts, and the scope of the present disclosure is not limited in this regard.

At block 1410, the network device 120 transmits, to the terminal device 110, an eleventh indication for a channel state information, CSI, report for model selection for beam prediction. At block 1420, the network device 120 receives, from the terminal device 110, a plurality of RSRP differences associated with a plurality of models for beam prediction, RSRP difference associated with each model of the plurality of models being determined based on reference signal received power, RSRP, of a plurality of beams and processed RSRP of the plurality of beams associated with the model, wherein the processed RSRP of the plurality of beams associated with the model are obtained based on the model and RSRP of a subset of the plurality of beams associated with the model, a different model corresponding to a different beam combination. At block 1430, the network device 120 determines a target model from the plurality of models, based on the plurality of RSRP differences associated with the plurality of models. At block 1440, the network device 120 transmits, to the terminal device 110, a twelfth indication for the target model or a beam combination associated with the target model.

Those skilled in the art can understand that all operations and features as described above with reference to FIG. 6 are likewise applicable to the method 1400 and have similar effects.

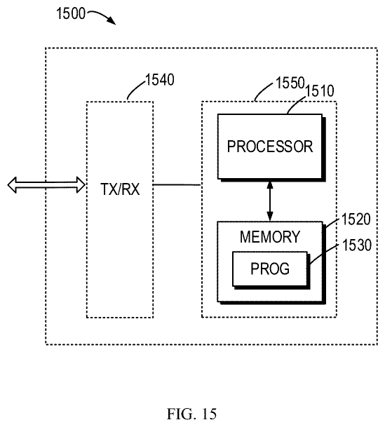

FIG. 15 is a simplified block diagram of a device 1500 that is suitable for implementing some embodiments of the present disclosure. The device 1500 can be considered as a further example embodiment of the terminal device 110 as shown in FIG. 1 or network device 120 as shown in FIG. 1. Accordingly, the device 1500 can be implemented at or as at least a part of the network device 120 or the terminal device 110 as shown in FIG. 1.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 1-14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

In some embodiments, a terminal device comprises circuitry configured to perform method 700, 800, 1100 and/or 1200.

In some embodiments, a network device comprises circuitry configured to perform method 900, 1000, 1300 and/or 1400.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques, terminal devices or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
generating, at a terminal device, a plurality of encoded channel state information, CSI, based on CSI and a plurality of encoding models for CSI feedback, the CSI being obtained based on a CSI reference signal, CSI-RS, from a network device;
obtaining a plurality of recovered CSI, the plurality of recovered CSI being generated based on a plurality of decoding models for CSI feedback and the plurality of encoded CSI, the plurality of decoding models corresponding to the plurality of encoding models;
determining difference information of the plurality of encoding models based on the CSI and the plurality of recovered CSI; and
determining a target encoding model, the target encoding model being determined from the plurality of encoding models based on the difference information.

2.-6. (canceled)

7. The method of claim 1, further comprising:
transmitting the plurality of encoded CSI to the network device; and
wherein obtaining the plurality of recovered CSI comprises:
receiving the plurality of recovered CSI from the network device.

8.-10. (canceled)

11. The method of claim 7, wherein receiving the plurality of recovered CSI from the network device comprises:
receiving, from the network device, the plurality of recovered CSI in a downlink control information, DCI.

12.-13. (canceled)

14. The method of claim 11, further comprising:
determining a correspondence between the plurality of encoding models and the plurality of recovered CSI based on a CSI report associated with a CSI report indicator comprised in the DCI, or based on a CSI report associated with a CSI trigger state comprised in the DCI.

15. The method of claim 11, further comprising:
determining a correspondence between the plurality of encoding models and the plurality of recovered CSI based on a plurality of encoding models associated with a previous CSI report having a smallest time interval with the DCI.

16. (canceled)

17. The method of claim 11, further comprising:
determining a correspondence between the CSI-RS and the plurality of recovered CSI based on a CSI-RS associated with a previous CSI report having a smallest time interval with the DCI.

18. The method of claim 7, wherein receiving the plurality of recovered CSI from the network device comprises:
receiving, from the network device, the plurality of recovered CSI in a fourth indication for a further CSI report; and
obtaining the plurality of recovered CSI from the fourth indication for the further CSI report.

19. (canceled)

20. The method of claim 18, further comprising:
determining a correspondence between the plurality of encoding models and the plurality of recovered CSI based on model information comprised in the fourth indication, the model information comprising a plurality of model indicators, or a model group indicator, or one model indicator for determination of encoding models in a model group comprising the model indicator.

21. The method of claim 18, further comprising:
determining a correspondence between the CSI-RS and the plurality of recovered CSI based on a CSI-RS associated with the further CSI report.

22. (canceled)

23. The method of claim 18, further comprising:
determining a correspondence between the CSI-RS and the plurality of recovered CSI based on a CSI-RS associated with a previous CSI report having a smallest time interval with the further CSI report.

24. The method of claim 18, wherein the CSI report is associated with the further CSI report, and the method further comprising:
determining a correspondence between the CSI-RS and the plurality of recovered CSI based on the CSI-RS associated with the CSI report associated with the further CSI report.

25. The method of claim 1, wherein the terminal device is configured the plurality of decoding models, and obtaining the plurality of recovered CSI comprises:
generating the plurality of recovered CSI based on the plurality of encoded CSI and the plurality of decoding models.

26. The method of claim 25, further comprising:
transmitting, to the network device, a fifth indication for support of the plurality of decoding models.

27. The method of claim 1, wherein determining the target encoding model comprises:
determining the target encoding model based on the difference information; and
the method further comprising:
transmitting, to the network device, a sixth indication for a target decoding model, the target decoding model corresponding to the target encoding model.

28. The method of claim 1, further comprising:
transmitting the difference information to the network device; and
receiving, from the network device, a seventh indication for the target encoding model; and
wherein determining the target encoding model comprises:
determining the target encoding model based on the seventh indication.

29.-50. (canceled)

51. A method of communication, comprising:
receiving, at a terminal device from a network device, a ninth indication for a channel state information, CSI, report for model selection for beam prediction, the ninth indication comprising information indicating a plurality of beams to be reported,
transmitting, to the network device, reference signal received power, RSRP, of the plurality of beams; and
receiving, from the network device, a tenth indication for a beam combination to be reported for beam prediction, the beam combination being a subset of the plurality of beams.

52. A method of communication, comprising:
receiving, at a terminal device from a network device, a eleventh indication for a channel state information, CSI, report for model selection for beam prediction;
obtaining, for each model of a plurality of models for beam prediction, processed reference signal received power, RSRP, of a plurality of beams based on the model and RSRP of a subset of the plurality of beams associated with the model, a different model corresponding to a different beam combination;
determining, for each model of the plurality of models, a RSRP difference based on the RSRP of the plurality of beams and the processed RSRP of the plurality of beams associated with the model; and
determining a target model, the target model being determined based on the plurality of RSRP differences from the plurality of models.

53. The method of claim 52, further comprising:
transmitting, to the network device, a plurality of RSRP differences associated with the plurality of models;
receiving, from the network device, a twelfth indication for the target model or a beam combination associated with the target model; and
wherein determining the target model comprises:
determining the target model based on the twelfth indication.

54. The method of claim 52, wherein determining the target model comprises:
determining the target model based on the plurality of RSRP differences associated with the plurality of models; and
the method further comprising:
transmitting, to the network device, a thirteenth indication for the target model, or a beam combination associated with the target model.

55. The method of claim 52, further comprising:
determining the plurality of models based on information associated with a plurality of CSI reference signals comprised in the eleventh indication.

56.-60. (canceled)
